(19) United States
(12) Patent Application Publication
(10) Pub. No.: US 2007/0073993 A1
(43) Pub. Date: Mar. 29, 2007

(54) Memory allocation in a multi-node computer

(75) Inventors: Kenneth R. Allen, Rochester, MN (US); William A. Brown, Pine Island, MN (US); Richard K. Kirkman, Rochester, MN (US); Kenneth C. Vossen, Mantorville, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/239,597

(22) Filed: Sep. 29, 2005

(51) Int. Cl. G06F 12/00

(52) U.S. Cl. 711/170

(57) ABSTRACT

Memory allocation in a multi-node computer, including evaluating memory affinity among nodes and allocating memory in dependence upon the evaluations. Evaluating memory affinity may include assigning to nodes weighted coefficients of memory affinity where each weighted coefficient represents a desirability of allocating memory of a node to a processor of a node, and allocating memory may include allocating memory in dependence upon the weighted coefficients of memory affinity.

### BACKGROUND OF THE INVENTION

1. Field of the Invention

The field of the invention is data processing, or, more specifically, methods, apparatus, and products for memory allocation in a multi-node computer.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

As computer systems have become more sophisticated, their design has become increasingly modular. Often computer systems are implemented with multiple modular nodes, each node containing one or more computer processors, a quantity of memory, or both processors and memory. Complex computer systems may include many nodes and sophisticated bus structures for transferring data among the nodes.

The access time for a processor on a node to access memory on a node varies depending on which node contains the processor and which node contains the memory to be accessed. A memory access by a processor to memory on the same node with the processor takes less time than a memory access by a processor to memory on a different node. Access to memory on the same node is faster because access to memory on a remote node must traverse more computer hardware, more buses, bus drivers, memory controllers, and so on, between nodes.

The level of computer hardware separation between nodes containing processors and memory is referred to as “memory affinity”—or simply as “affinity.” A node has its greatest memory affinity with itself because its processors can access its memory faster than memory on other nodes. Memory affinity between a node containing a processor and the node or nodes on which memory is installed decreases as the level of hardware separation increases.

Consider an example of a computer system characterized by the information in the following table:

| | Proportion of Processor | Proportion of Memory |
|---|---|---|
| Node | Capacity | Capacity |
| 0 | 50% | 50% |
| 1 | 50% | 5% |
| 2 | 0% | 45% |

The table describes a system having three nodes, nodes 0, 1, and 2, where proportion of processor capacity represents the processor capacity on each node relative to the entire system, and proportion of memory capacity represents the proportion of random access memory installed on each node relative to the entire system. An operating system may enforce affinity, allocating memory to a process on a processor only from memory on the same node with the processor. In this example, node 0 benefits from enforcement of affinity because node 0, with half the memory on the system, is likely to have plenty of memory to meet the needs of processes running on its processors. Node 0 also benefits from enforcement of memory affinity because access to memory on the same node with the processor is fast.

Not so for node 1. Node 1, with only five percent of the memory on the system is not likely to have enough memory to satisfy needs of processes running on its processors. In enforcing affinity, every time a process or thread of execution gains control of a processor on node 1, the process or thread is likely to encounter a swap of the contents of RAM out to a disk drive to clear memory and a load of the contents of its memory from disk, an extremely inefficient operation referred to as ‘swapping’ or ‘thrashing.’ Turning off affinity enforcement completely for memory on processors' local node may alleviate thrashing, but running with no enforcement of affinity also loses the benefit of affinity enforcement between processors and memory on well balanced nodes such as node 0 in the example above.

### SUMMARY OF THE INVENTION

Methods, apparatus, and products are disclosed that reduce the risk of thrashing for memory allocation in a multi-node computer by evaluating memory affinity among nodes and allocating memory in dependence upon the evaluations. Evaluating memory affinity may include assigning to nodes weighted coefficients of memory affinity where each weighted coefficient represents a desirability of allocating memory of a node to a processor of a node, and allocating memory may include allocating memory in dependence upon the weighted coefficients of memory affinity.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in memory allocation in a multi-node computer according to embodiments of the present invention.

FIG. 2 sets forth a block diagram of a further exemplary computer for memory allocation in a multi-node computer.

FIG. 3 sets forth a flow chart illustrating an exemplary method for memory allocation in a multi-node computer according to embodiments of the present invention that includes evaluating memory affinity among nodes.

FIG. 4 sets forth a flow chart illustrating a further exemplary method for memory allocation in a multi-node computer according to embodiments of the present invention.

FIG. 5 sets forth a flow chart illustrating a further exemplary method for memory allocation in a multi-node computer according to embodiments of the present invention.

FIG. 6 sets forth a flow chart illustrating a further exemplary method for memory allocation in a multi-node computer according to embodiments of the present invention.

FIG. 7 sets forth a flow chart illustrating a further exemplary method for memory allocation in a multi-node computer according to embodiments of the present invention.

FIG. 8 sets forth a flow chart illustrating a further exemplary method for memory allocation in a multi-node computer according to embodiments of the present invention.

FIG. 9 sets forth a flow chart illustrating a further exemplary method for memory allocation in a multi-node computer according to embodiments of the present invention.

### DETAILED DESCRIPTION OF EXEMPLARY EMBODIMENTS

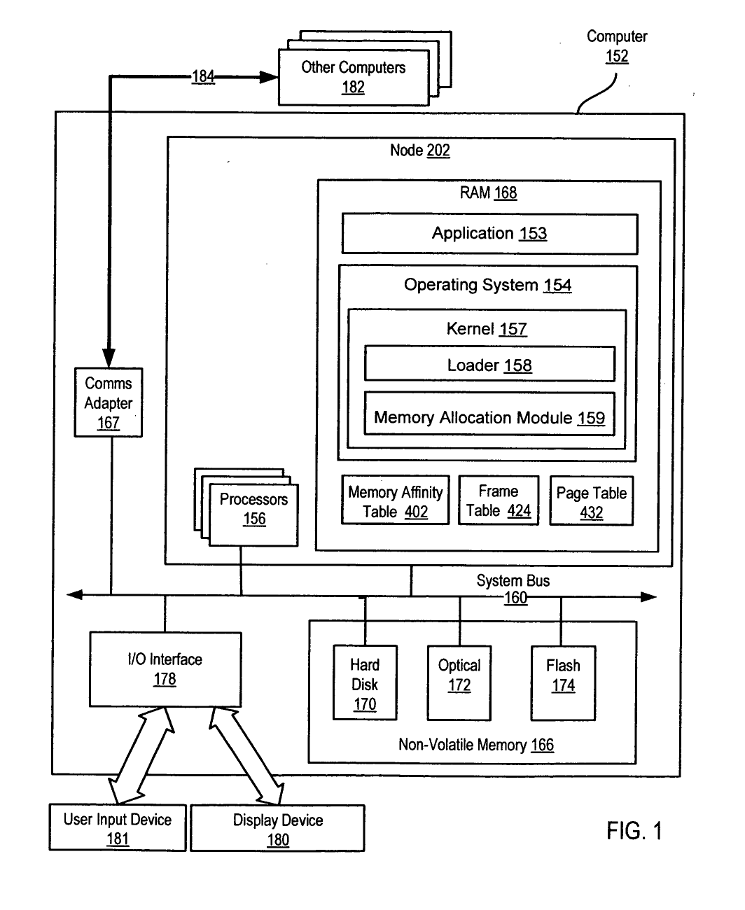

Exemplary methods, apparatus, and products for memory allocation in a multi-node computer according to embodiments of the present invention are described with reference to the accompanying drawings, beginning with FIG. 1. Memory allocation in a multi-node computer in accordance with the present invention is generally implemented with computers, that is, with automated computing machinery. For further explanation, therefore, FIG. 1 sets forth a block diagram of automated computing machinery comprising an exemplary computer (152) useful in memory allocation in a multi-node computer according to embodiments of the present invention. The computer (152) of FIG. 1 includes at least one node (202). A node is a computer hardware module containing one or more computer processors, a quantity of memory, or both processors and memory. In this specification, a node containing one or more processors is sometimes referred to as a ‘processor node,’ and a node containing memory is sometimes referred to as a ‘memory node.’ Nodes containing both a quantity of memory and processors may be referred to as both processor nodes and memory nodes. Node (202) of FIG. 1 includes at least one computer processor (156) or ‘CPU’ as well as random access memory (168) (‘RAM’) which is connected through a system bus (160) to processor (156) and to other components of the computer. As a practical matter, systems for memory allocation in a multi-node computer according to embodiments of the present invention typically include more than one node, more than one computer processor, and more than one RAM circuit.

Stored in RAM (168) is an application program (153), computer program instructions for user-level data processing implementing threads of execution. Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154) contains a core component called a kernel (157) for allocating system resources, such as processors and physical memory, to instances of an application program (153) or other components of the operating system (154). Operating system (154) including kernel (157), in the method of FIG. 1, is shown in RAM (168), but many components of such software typically are stored in non-volatile memory (166) also.

The operating system (154) of FIG. 1 includes a loader (158). Loader (158) is a module of computer program instructions that loads an executable program from a load source such as a disk drive, a tape, or a network connection, for example, for execution by a computer processor. The loader reads and interprets metadata contents of the executable program, allocates memory required by the program, loads code and data segments of the program into memory, and registers the program with a scheduler in the operating system for execution, typically by placing an identifier for the new program in a scheduler's ready queue. In this example, the loader (158) is a module of computer program instructions improved according to embodiments of the present invention to allocate memory in a multi-node computer by evaluating memory affinity among nodes and allocating memory in dependence upon the evaluations.

The operating system (154) of FIG. 1 includes a memory allocation module (159). Memory allocation module (159) of FIG. 1 is a module of computer program instructions that provides an application programming interface (‘API’)through which application programs and other components of the operating system may dynamically allocate, reallocate, or free previously allocated memory. Function calls to the API of the memory allocation module (159), such as, for example, ‘malloc( )’, ‘realloc( )’, and ‘free( )’, satisfy dynamic memory allocation requirements during program execution. In this example, the memory allocation module (159) is a module of computer program instructions improved according to embodiments of the present invention to allocate memory in a multi-node computer by evaluating memory affinity among nodes and allocating memory in dependence upon the evaluations.

Also stored in RAM (168) is a page table (432) representing as a data structure a map between the virtual memory address space of computer system and the physical memory address space in the system of FIG. 1. The virtual memory address space is broken into fixed-size blocks called ‘pages,’ while the physical memory address space is broken into blocks of the same size called ‘frames.’ The virtual memory address space provides a program with a block of memory in which to execute that may be much larger than the actual amount of physical memory installed in the computer system. While a program executes in a block of virtual memory space that appears contiguous, the actual physical memory containing the program may be fragmented throughout the computer system. When a reference to a page of virtual memory occurs during execution of a program, the operating system (154) looks up the corresponding frame of physical memory in the page table (432) associated with the program making the reference. The page table (432) therefore allows a program to execute in the virtual address space without regard to its location in physical memory. In associating the page table (432) of FIG. 1 with a program, some operating systems maintain a page table (432) for each executing program, while other operating systems may assign each program a portion of one large page table (432) maintained for the entire system.

Upon creating, expanding, or modifying a page table (432) for a program, the operating system (154) allocates frames of physical memory to the pages in the page table (432). The operating system (154) locates unallocated frames to assign to the page table (432) through a frame table (424). Frame table (424) is stored in RAM (168) and represents information regarding frames of physical memory in the system of FIG. 1. In associating the frame table (424) of FIG. 1 with frames on a node, some operating systems may maintain a frame table (424) for each node that contains a list of the unallocated frames on the node, while other operating systems may maintain one large frame table (424) for the entire system that contains information on all frames in all nodes. Frame table (424) indicates whether a frame is mapped to a page in the virtual memory space. Frames not mapped to pages are unallocated and therefore available for storing code and data.

Also stored in RAM (168) is a memory affinity table (402) representing evaluations of memory affinity between processor nodes and memory node. High evaluations of memory affinity exist between processor nodes and memory nodes in close proximity because data written to or read from a node of high memory affinity with a processor node traverses less computer hardware, fewer memory controllers, and fewer bus drivers in traveling to or from such a high affinity memory node. In addition, memory affinity may be evaluated highly for memory nodes with relatively large portions of available memory. For example, a memory node containing more unallocated frames than another memory node with a similar physical proximity to a processor node may have a higher evaluation of memory affinity with respect to the processor node. Evaluations of memory affinity may be represented in the memory affinity table (402) using a memory affinity ranking or a weighted coefficient of memory affinity. A memory affinity rank may be, for example, an ordinal integer that indicates the order of memory nodes from which frames are allocated to a processor node executing a program. Weighted coefficients of memory affinity, for example, may indicate the proportion of frame allocations to be made from memory nodes to a node processor. In associating the memory affinity table (402) of FIG. 1 with a processor node, some operating systems maintain a memory affinity table (402) for each processor node, while other operating systems may assign each processor node (156) a portion of one large memory affinity table (402) maintained for the entire system.

Computer (152) of FIG. 1 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art. Page table (432), frame table (424), memory affinity table (402), and application program (153) in the method of FIG. 1 are shown in RAM (168), but many components of such software typically are stored in non-volatile memory (166) also.

The example computer of FIG. 1 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 1 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

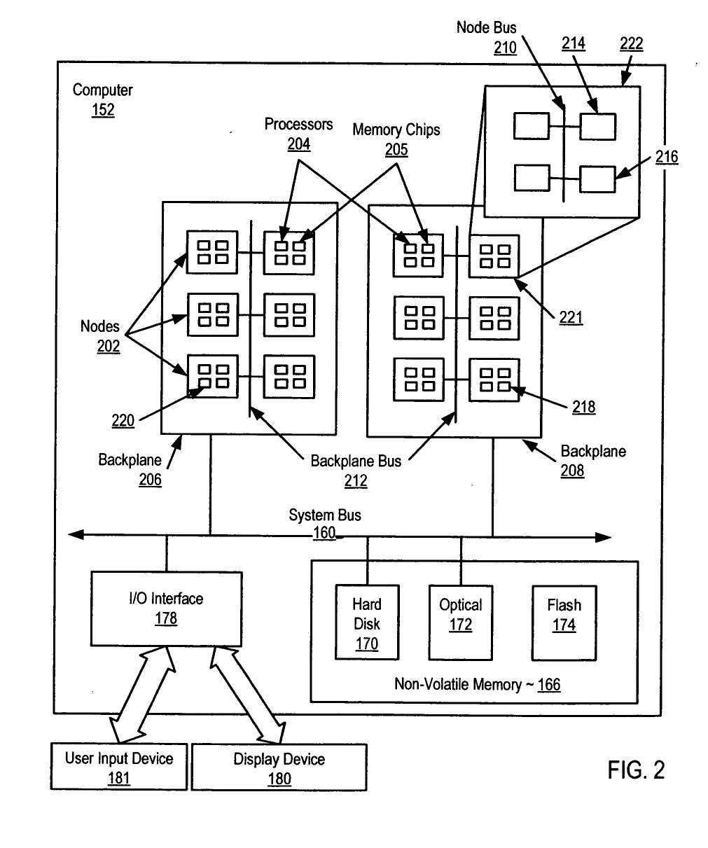

For further explanation, FIG. 2 sets forth a block diagram of a further exemplary computer (152) for memory allocation in a multi-node computer. The system of FIG. 2 includes random access memory implemented as memory integrated circuits referred to as ‘memory chips’ (205) included in nodes (202) installed on backplanes (206), with each backplane coupled through system bus (160) to other components of computer (152). The nodes (202) may also include computer processors (204), also in the form of integrated circuits installed on a node. The nodes on the backplanes are coupled for data communications through backplane buses (212), and the processor chips and memory chips on nodes are coupled for data communications through node buses, illustrated at reference (210) on node (222), which expands the drawing representation of node (221).

A node may be implemented, for example, as a multi-chip module (‘MCM’). An MCM is an electronic system or subsystem with two or more bare integrated circuits (bare dies) or ‘chip-sized packages’ assembled on a substrate. In the method of FIG. 2, the chips in the MCMs are computer processors and computer memory. The substrate may be a printed circuit board or a thick or thin film of ceramic or silicon with an interconnection pattern, for example. The substrate may be an integral part of the MCM package or may be mounted within the MCM package. MCMs are useful in computer hardware architectures because they represent a packaging level between application-specific integrated circuits (‘ASICs’)and printed circuit boards.

The nodes of FIG. 2 illustrate levels of hardware memory separation or memory affinity. A processor (214) on node (222) may access physical memory:
in a memory chip (216) on the same node with the processor (214) accessing the memory chip,
in a memory chip (218) on another node on the same backplane (208), or
in a memory chip (220) on another node on another backplane (206).

Memory chip (216) is referred to as ‘local’ with respect to processor (214) because memory chip (216) is on the same node as processor (214). Memory chips (218 and 220) however are referred to as ‘remote’ with respect to processor (214) because memory chips (218 and 220) are on different nodes than processor (214). Accessing remote memory on the same backplane takes longer than accessing local memory, because data written to or read from remote memory by a processor traverses more computer hardware, more memory controllers, and more bus drivers in traveling to or from the remote memory. Accessing memory remotely on another backplane takes even longer—for the same reasons. A processor node's highest memory affinity is with itself; local memory provides the fastest available memory access. A memory node on the same backplane with a processor node has a higher evaluation of memory affinity with the processor node than a memory node on another backplane. The computer architecture so described is for explanation, not for limitation of the computer memory. Several nodes may be installed upon printed circuit boards, for example, with the printed circuit boards plugged into backplanes, thereby creating an additional level of memory affinity not illustrated in FIG. 2. Other aspects of computer architecture as will occur to those of skill in the art may affect processor-memory affinity, and all such aspects are within the scope of allocating memory in a multi-node computer according to embodiments of the present invention.

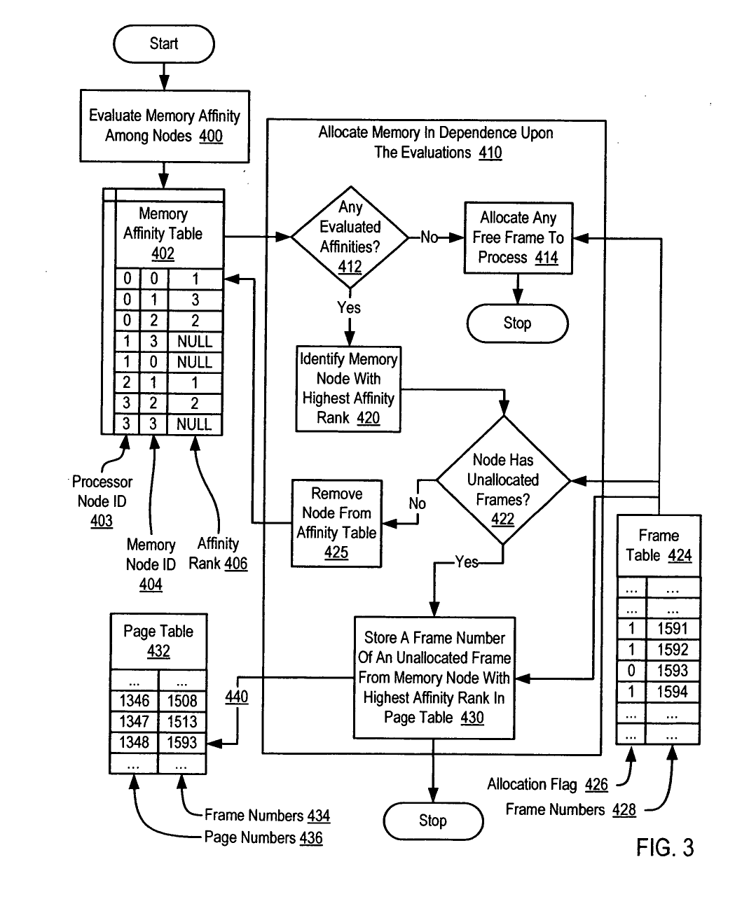

For further explanation, FIG. 3 sets forth a flow chart illustrating an exemplary method for memory allocation in a multi-node computer according to embodiments of the present invention that includes evaluating (400) memory affinity among nodes. In the method of FIG. 3, evaluating (400) memory affinity among nodes may be carried out by calculating a memory affinity rank (406) for each memory node available to a processor node based on system parameters. In the method of FIG. 3, memory affinity rank (406) is represented by ordinal integers that indicate the order in which an operating system allocates memory from memory nodes to a processor node. The system parameters used in calculating memory affinity rank (406) may be static and stored in non-volatile memory by a system administrator when the computer system is installed, such as, for example, the number of processor nodes, the quantity of memory installed on nodes, or the physical locations of the nodes (MCM, backplane, and the like). The system parameters may however change dynamically as the computer system operates, such as, for example, when the number of unallocated frames in each node changes dynamically by being freed, allocated, or reallocated. In addition, system parameters may be calculated and stored in RAM or in non-volatile memory during system powerup or initial program load (‘booting’).

Memory affinity table (402) of FIG. 3 stores evaluations of memory affinity among nodes. Each record in table (402) specifies an evaluation (406) of memory affinity of a memory node (404) to a processor node (403). The evaluations of memory affinity (406) in the method of FIG. 3 are memory affinity values represented by an ordinal integer memory affinity rank (406) that indicates the order in which an operating system will allocate memory to a processor node (403) from a memory node (404) identified in the table. Lower ordinal integers represent higher memory affinity ranks (406)—ordinal integer 1 is a higher memory affinity rank than ordinal integer 2, ordinal integer 2 is a higher memory affinity rank than ordinal integer 3, and so on, with the lowest ordinal number corresponding to the memory node with the highest evaluation of memory affinity to a processor node and the highest ordinal number corresponding to the memory node with the lowest evaluation of memory affinity to a processor node.

The method of FIG. 3 also includes allocating (410) memory in dependence upon the evaluations. Allocating (410) memory in dependence upon the evaluations according the method of FIG. 3 includes determining (412) whether there are any memory nodes in the system having evaluated affinities with a processor node, that is, to a processor node for which memory is to be allocated. In the example of FIG. 3, determining whether there are any memory nodes in the system having evaluated affinities with a processor node may be carried out by determining whether there are evaluated affinities in the table for the particular processor node to which memory is to be allocated. An absence of an evaluated memory affinity in this example is represented by a null entry in the table.

If there are no memory nodes in the system having evaluated affinities with the processor node, the method of FIG. 3 includes allocating (414) any free memory frame available anywhere on the system regardless of memory affinity. Processor node 1 in memory affinity table (402), for example, has no evaluated affinities to memory nodes, indicated by null values in column (406), so that allocations of memory to processor node 1 may be from any free frames anywhere in system memory regardless of location.

If there are memory nodes in the system having evaluated affinities with the processor node, the method of FIG. 3 continues by identifying (420) the memory node with the highest memory affinity rank (406), and, if that node has unallocated frames, allocating memory from that node by storing (430) a frame number (428) of a frame of memory from that memory node in page table (432). Each record of page table (432) associates a page number (436) and a frame numbers (434). According to the method of FIG. 3, frame number ‘1593’ representing a frame from a memory node with the highest memory affinity rank (406) has been allocated to page number ‘1348’ in page table (432) as indicated by arrow (440).

If the memory node having the highest memory affinity rank (406) has no unallocated frames, the method of FIG. 3 continues by removing (425) the entry for that node from the memory affinity table (402) and loops to again determine (412) whether there are memory nodes in the system having evaluated affinities with the processor node, identify (420) the memory node with highest memory affinity rank (406), and so on.

Whether the node with highest memory affinity rank (406) has unallocated frames may be determined (422) by use of a frame table, such as, for example, the frame table illustrated at reference (424) in FIG. 3. Each record in frame table (424) represents a memory frame identified by frame number (428) and specifies by an allocation flag (426) whether the frame is allocated. An allocated frame has its associated allocation flag set to ‘1,’ and a free frame's allocation flag is reset to ‘0.’

Allocating a frame from such a frame table (424) includes setting the frame's allocation flag to ‘1.’ In the frame table (424) of FIG. 3, frame numbers ‘1591,’ ‘1592,’ and ‘1594’ are allocated. Frame number ‘1593’ however remains unallocated.

An alternative form of frame table may be implemented as a ‘free frame table’ containing only frame numbers of frames free to be allocated. Allocating a frame from a free frame table includes deleting the frame number of the allocated frame from the free frame table. Other forms of frame table, ways of indicating free and allocated frames, may occur to those of skill in the art, and all such forms are well within the scope of the present invention.

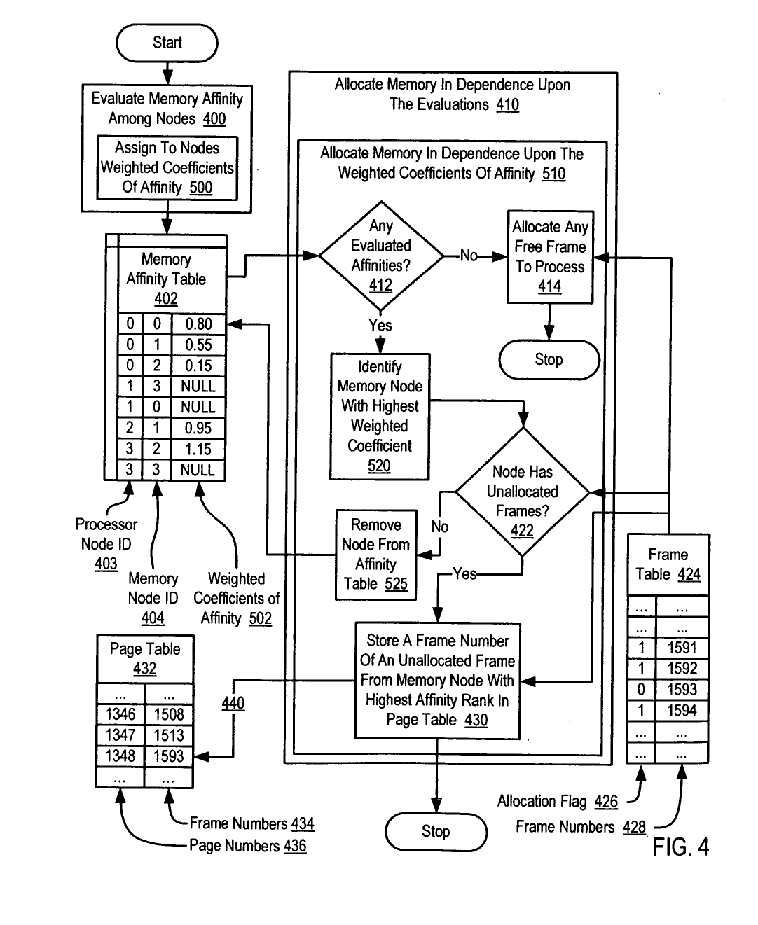

For further explanation, FIG. 4 sets forth a flow chart illustrating a further exemplary method for memory allocation in a multi-node computer according to embodiments of the present invention that includes evaluating (400) memory affinity among nodes and allocating (410) memory in dependence upon the evaluations. In the method of FIG. 4, evaluating (400) memory affinity among nodes includes assigning (500) to nodes weighted coefficients of memory affinity (502), where each weighted coefficient (502) represents a desirability of allocating memory of a node to a processor of a node. Assigning (500) weighted coefficients of memory affinity (502) may be carried out by calculating weighted coefficients of memory affinity (502) for each processor node and memory node having an evaluated memory affinity with the processor node based on system parameters and storing the weighted coefficients of memory affinity (502) in a memory affinity table such as the one illustrated at reference (402). Each record of memory affinity table (402) specifies a weighted coefficient of memory affinity (502) of a memory node (404) to a processor node (403). As illustrated, processor node 0 has a coefficient of memory affinity of 0.80 to memory node 0, that is, processor node 0's coefficient of memory affinity with itself is 0.80. Processor node 0's coefficient of memory affinity to memory node 1 is 0.55. And so on. System parameters used in calculating weighted coefficients of memory affinity (502) may include, for example, the number of processor nodes in the system, physical locations of the nodes (MCM, backplane, and the like), the quantity of memory on each memory node, the number of unallocated frames in each memory node, and other system parameters pertinent to evaluation of memory affinity as will occur to those of skill in the art.

The evaluations of memory affinity (502) in the memory affinity table (402) are weighted coefficients of memory affinity (502). Higher weighted coefficients of memory affinity (502) represent higher evaluations of memory affinity. A weighted coefficient of 0.65 represents a higher evaluation of memory affinity than a weighted coefficient of 0.35; a weighted coefficient of 1.25 represents a higher evaluation of memory affinity than a weighted coefficient of 0.65; and so on, with the highest weighted coefficient of memory affinity corresponding to the memory node with the highest evaluation of memory affinity to a processor node and the lowest weighted coefficient of memory affinity corresponding to the memory node with the lowest evaluation of memory affinity to a processor node.

The method of FIG. 4 also includes allocating (410) memory in dependence upon the evaluations. Allocating (410) memory in dependence upon the evaluations according the method of FIG. 4 includes allocating (510) memory in dependence upon weighted coefficients of memory affinity. In the method of FIG. 4, allocating (510) memory in dependence upon weighted coefficients of memory affinity includes determining (412) whether there are any memory nodes in the system having evaluated affinities to a processor node, that is, to a processor node for which memory is to be allocated. In the example of FIG. 4, determining whether there are any memory nodes in the system having evaluated affinities with a processor node may be carried out by determining whether there are evaluated affinities in the table for the particular processor node to which memory is to be allocated. An absence of an evaluated memory affinity in this example is represented by a null entry in the table.

If there are no memory nodes in the system having evaluated affinities with the processor node, the method of FIG. 4 includes allocating (414) any free memory frame available anywhere on the system regardless of memory affinity. Processor node 1 in memory affinity table (402), for example, has no evaluated affinities to memory nodes, indicated by null values in column (502), so that allocations of memory to processor node 1 may be from any free frames anywhere in system memory regardless of location.

If there are memory nodes in the system having evaluated affinities with the processor node, the method of FIG. 4 continues by identifying (520) the memory node with the highest weighted coefficients of memory affinity (502), and, if that node has unallocated frames, allocating memory from that node by storing (430) a frame number (428) of a frame of memory from that memory node in page table (432). If the memory node having the highest weighted coefficients of memory affinity (502) has no unallocated frames, the method of FIG. 4 continues by removing (525) the entry for that node from the memory affinity table (402) and loops to again determining (412) whether there are memory nodes in the system having evaluated affinities with the processor node, identifying (520) the memory node with highest weighted coefficients of memory affinity (502), and so on.

Whether the node with highest weighted coefficients of memory affinity (502) has unallocated frames may be determined (422) from a frame table (424) for the node. Frame table (424) of FIG. 4 and page table (432) of FIG. 4 are similar to the frame table and page table of FIG. 3. In FIG. 4, frame table (424) is represented as a data structure that associates allocations flags (426) with frame numbers (428) of frames in memory nodes. Page table (432) of FIG. 4 is represented as a data structure that that associates frame numbers (434) of frames in memory nodes with page numbers (436) in the virtual memory space. According to the method of FIG. 4, frame number ‘1593’ representing a frame from a memory node with the highest weighted coefficient of memory affinity (502) has been allocated to page number ‘1348’ in page table (432) as indicated by arrow (440).

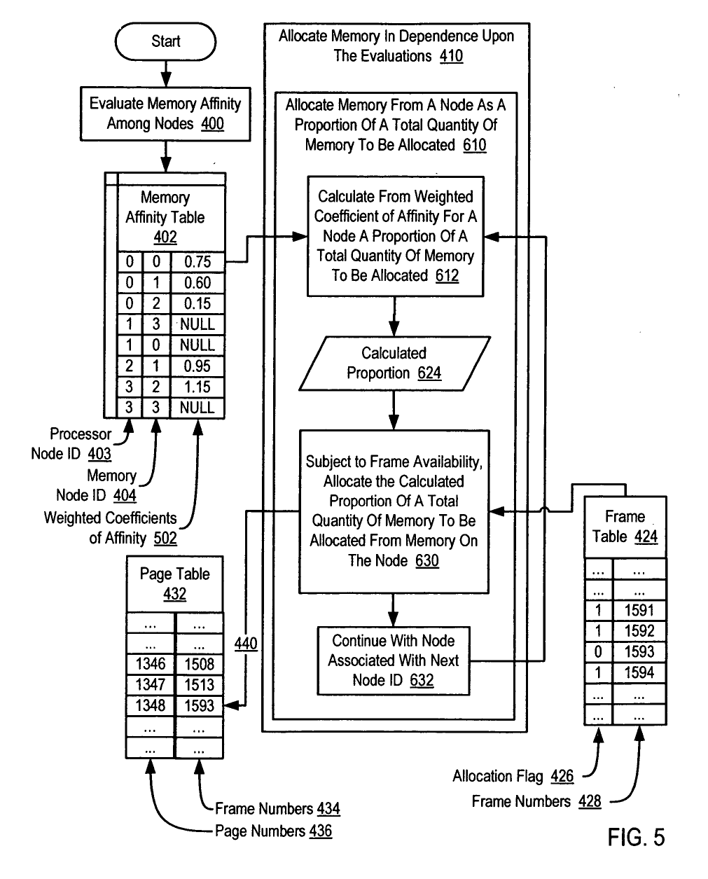

For further explanation, FIG. 5 sets forth a flow chart illustrating a further exemplary method for memory allocation in a multi-node computer according to embodiments of the present invention that includes evaluating (400) memory affinity among nodes and allocating (410) memory in dependence upon the evaluations. Evaluating (400) memory affinity among nodes according to the method of FIG. 5 may be carried out by calculating a weighted coefficient of memory affinity (502) for each processor node and memory node having an evaluated memory affinity with the processor node based on system parameters and storing the weighted coefficients of memory affinity (502) in a memory affinity table (402). Each record specifies an evaluation (502) of memory affinity for a memory node (404) to a processor node (403). The evaluations of memory affinity (502) in the memory affinity table (402) are weighted coefficients of memory affinity that indicate a proportion of a total quantity of memory to be allocated.

The method of FIG. 5 also includes allocating (410) memory in dependence upon the evaluations of memory affinity, that is, in dependence upon the weighted coefficients of memory affinity (502). Allocating (410) memory in dependence upon the evaluations according to the method of FIG. 5 includes allocating (610) memory from a node as a proportion of a total quantity of memory to be allocated. Allocating (610) memory from a node as a proportion of a total quantity of memory to be allocated may be carried out by allocating memory from a node as a proportion of a total quantity of memory to be allocated to a processor node. A total quantity of memory to be allocated may be identified as a predetermined quantity of memory for allocation such as, for example, the next 5 megabytes to be allocated.

Allocating (610) memory from a node as a proportion of a total quantity of memory to be allocated according to the method of FIG. 5 includes calculating (612) from a weighted coefficient of memory affinity (502) for a node a proportion (624) of a total quantity of memory to be allocated. A proportion (624) of a total quantity of memory to be allocated by a memory node to a processor node from memory nodes having evaluated affinities to the processor may be calculated as the total quantity of memory to be allocated times the ratio of a value of a weighted coefficient of memory affinity (502) for the memory node to a total value of all weighted coefficients of memory affinity (502) for memory nodes having evaluated affinities to the processor node. For processor node 0 in table (402), the total of all weighted coefficients of memory affinity for memory processors having evaluated affinities with processor node 0 (that is, for memory nodes 0, 1, and 2) is 1.5. Using a total quantity of memory to be allocated of 5 megabytes in the example of in FIG. 5, the proportion (624) of a total quantity of memory to be allocated from memory of the nodes associated with memory nodes 0, 1, and 2 respectively may be calculated as:
Node 0: (0.75 evaluated memory affinity for node 0)÷(1.5 total evaluated memory affinity)×5 MB=2.5 MB
Node 1: (0.60 evaluated memory affinity for node 1)÷(1.5 total evaluated memory affinity)×5 MB=2.0 MB
Node 2: (0.15 evaluated memory affinity for node 0)÷(1.5 total evaluated memory affinity)×5 MB=0.5 MB

In this example, allocating (610) memory from a node as a proportion of a total quantity of memory of 5 MB to be allocated according to the method of FIG. 5 may be carried out by allocating the next 5 MB to node 0 by allocating the first 2.5 MB of the 5 MB allocation from node 0, the next 2.0 MB from node 1, and the final 0.5 MB of the 5 MB allocation from node 2. All such allocations are subject to availability of frames in the memory nodes. In particular in the example of FIG. 5, allocating (610) memory from a node as a proportion of a total quantity of memory to be allocated also includes allocating (630) the calculated proportion (624) of a total quantity of memory to be allocated from memory on the node, subject to frame availability. Whether unallocated frames exist on a memory node may be determined by use of frame table (424). Frame table (424) associates frame numbers (428) for frames in memory nodes with allocations flags (426) that indicate whether a frame of memory is allocated.

Allocating (630) the calculated proportion (624) of a total quantity of memory according to the method of FIG. 5 may include calculating the number of frames needed to allocate the calculated proportion (624) of a total quantity of memory to be allocated. Calculating the number of frames needed may be accomplished by dividing the frame size into the proportion (624) of the total quantity of memory to be allocated. Continuing the example calculation above, where the total of all weighted coefficients of memory affinity for memory processors having evaluated affinities with processor node 0 is 1.5, the total quantity of memory to be allocated is 5 megabytes, the proportion of the total quantity of memory to be allocated from nodes 0, 1, and 2 respectively is 2.5 MB, 2.0 MB, and 0.5 MB, and the frame size is taken as 2KB, then the number of frames to be allocated from nodes 0, 1, and 2 may be calculated as:
Node 0: 2.5 MB÷2 KB/frame=1280 frames
Node 1: 2.0 MB÷2 KB/frame=1024 frames
Node 2: 0.5 MB÷2 KB/frame=256 frames

Allocating (630) the calculated proportion (624) of a total quantity of memory according to the method of FIG. 5 may also be carried out by storing the frame numbers (428) of all unallocated frames from a memory node up to and including the number of frames needed to allocate the calculated proportion (624) of a total quantity of memory to be allocated from memory nodes into page table (432) for a program executing on a processor node. Each record of page table (432) of FIG. 5 associates a frame number (434) of a frame on a memory node with a page number (436) in the virtual memory space utilized by a program executing on a processor node. In the example of FIG. 5, therefore, frame number ‘1593’ representing a frame from a memory node with the highest weighted coefficient of memory affinity (502) has been allocated to page number ‘1348’ in page table (432) as indicated by arrow (440).

After allocating the number of frames needed to allocate the proportion (624) of a total quantity of memory to be allocated from the memory node, or after allocating all unallocated frames from a memory node, whichever comes first, the method of FIG. 5 continues (632) by looping to the next entry in the memory affinity table (402) associated with a memory node and, again, calculating (612) from a weighted coefficient of memory affinity (502) for a node a proportion of a total quantity of memory to be allocated, allocating (630) the calculated proportion (624) of a total quantity of memory to be allocated from memory on the node, subject to frame availability, and so on until allocation, subject to frame availability, of the proportion (624) of a total quantity of memory to be allocated for each memory node with an evaluated memory affinity (502) for the processor node for which a quantity of memory is to be allocated occurs. Upon allocating, subject to frame availability, the proportion (624) of a total quantity of memory to be allocated for each memory node with an evaluated memory affinity (502) for the processor node for which a quantity of memory is to be allocated according to the method of FIG. 5, any portion of the total number of allocations remaining unallocated may be satisfied from memory anywhere on the system regardless of memory affinity.

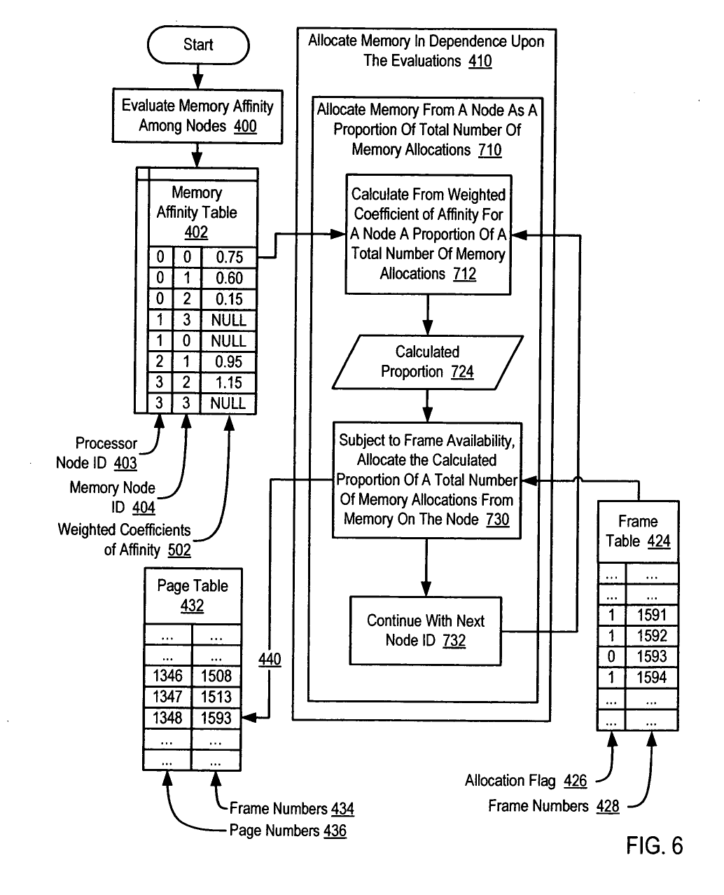

For further explanation, FIG. 6 sets forth a flow chart illustrating a further exemplary method for memory allocation in a multi-node computer according to embodiments of the present invention that includes evaluating (400) memory affinity among nodes and allocating (410) memory in dependence upon the evaluations. Evaluating (400) memory affinity among nodes according to the method of FIG. 6 may be carried out by calculating a weighted coefficient of memory affinity (502) for each memory node for each processor node based on system parameters and storing the weighted coefficients of memory affinity (502) in a memory affinity table (402).

Each record of memory affinity table (402) specifies an evaluation (502) of memory affinity for a memory node (404) to a processor node (403). The evaluations of memory affinity (502) in the memory affinity table (402) are weighted coefficients of memory affinity (502) that indicate a proportion of a total number of memory allocations to be allocated from memory nodes to a processor node.

The method of FIG. 6 also includes allocating (410) memory in dependence upon the evaluations of memory affinity, that is, in dependence upon the weighted coefficients of memory affinity (502). Allocating (410) memory in dependence upon the evaluations according to the method of FIG. 6 includes allocating (710) memory from a node as a proportion of a total number of memory allocations. Allocating (710) memory from a node as a proportion of a total number of memory allocations may be carried out by allocating memory from a node as a proportion of a total number of memory allocations to a processor node. In FIG. 6, the total number of memory allocations may be identified as a predetermined number of memory allocations such as, for example, the next 500 allocations of memory to a processor node.

Allocating (710) memory from a node as a proportion of a total number of memory allocations according to the method of FIG. 6 includes calculating (712) from a weighted coefficient of memory affinity (502) for a node a proportion (724) of a total number of memory allocations. A proportion (724) of a total number of memory allocations from a memory node to a processor node from memory nodes having evaluated affinities to the processor may be calculated as the total number of memory allocations times the ratio of a value of a weighted coefficient of memory affinity (502) for the memory node to a total value of all weighted coefficients of memory affinity (502) for memory nodes having evaluated affinities to the processor node. For processor node 0 in table (402), the total of all weighted coefficients of affinities for memory processors having evaluated affinities with processor node 0 (that is, for memory nodes 0, 1, and 2) is 1.5. Using a total number of memory allocations of 500 allocations in the example of FIG. 6, the proportion (724) of a total number of memory allocations to processor node 0 from memory nodes 0, 1, and 2 respectively may be calculated as:
Node 0: (0.75 evaluated memory affinity for node 0)÷(1.5 total evaluated memory affinity)×500 allocations=250 allocations
Node 1: (0.60 evaluated memory affinity for node 1)÷(1.5 total evaluated memory affinity)×500 allocations=200 allocations
Node 2: (0.15 evaluated memory affinity for node 0)÷(1.5 total evaluated memory affinity)×500 allocations=50 allocations

In this example, allocating (710) memory from a node as a proportion of a total number of 500 memory allocations according to the method of FIG. 6 may be carried out by allocating the next 500 allocations to node 0 by allocating the first 250 of the 500 allocations from node 0, the next 200 allocations from node 1, and the final 50 of the 500 from node 2. All such allocations are subject to availability of frames in the memory nodes, and all such allocations are implemented without regard to the quantity of memory allocated. In particular in the example of FIG. 6, allocating (710) memory from a node as a proportion of a total number of memory allocations also includes allocating (730) the calculated proportion (724) of a total number of memory allocations from memory on the node, subject to frame availability. Whether unallocated frames exist on a memory node may be determined by use of frame table (424). Frame table (424) associates frame numbers (428) for frames in memory nodes with allocations flags (426) that indicate whether a frame of memory is allocated.

Allocating (730) the calculated proportion (724) of a total number of memory allocations according to the method of FIG. 6 may be carried out by storing the frame numbers (428) of all unallocated frames from a memory node up to and including the calculated proportion (724) of a total number of memory allocations for the memory node into page table (432) for a program executing on a processor node. Each record of page table (432) of FIG. 6 associates a frame number (434) of a frame on a memory node with a page number (436) in the virtual memory space utilized by a program executing on a processor node. In the example of FIG. 6, therefore, frame number ‘1593’ representing a frame from a memory node with an evaluated memory affinity (here, a weighted memory affinity) to a processor node has been allocated to page number ‘1348’ in page table (432) as indicated by arrow (440).

After allocating the calculated proportion (724) of a total number of memory allocations from the memory node, or after allocating all unallocated frames from a memory node, whichever comes first, the method of FIG. 6 continues (732) by looping to the next entry in the memory affinity table (402) associated with a memory node and, again, calculating (712) from a weighted coefficient of memory affinity (502) for a node a proportion (724) of a total number of memory allocations, allocating (730) the calculated proportion (724) of a total number of memory allocations from memory on the node, subject to frame availability, and so on until allocation, subject to frame availability, of the calculated proportion (724) of a total number of memory allocations for each memory node with an evaluated memory affinity (502) for the processor node for which memory is to be allocated occurs. Upon allocating, subject to frame availability, the calculated proportion (724) of a total number of memory allocations for each memory node with an evaluated memory affinity (502) for the processor node for which memory is to be allocated according to the method of FIG. 6, any portion of the total number of allocations remaining unallocated may be satisfied from memory anywhere on the system regardless of memory affinity.

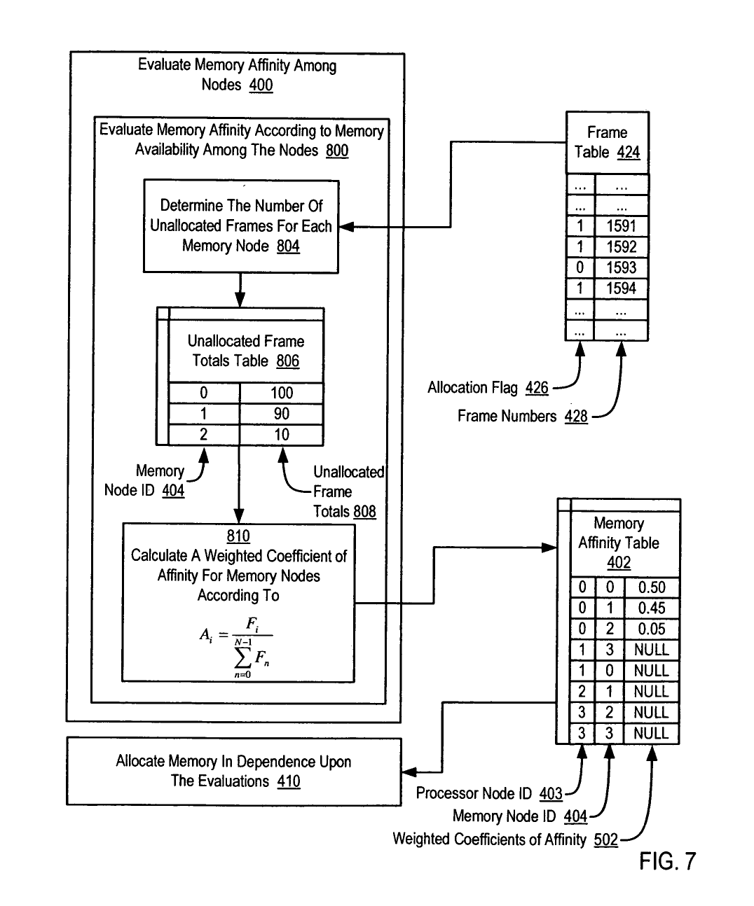

For further explanation, FIG. 7 sets forth a flow chart illustrating a further exemplary method for memory allocation in a multi-node computer according to embodiments of the present invention that includes evaluating (400) memory affinity among nodes and allocating (410) memory in dependence upon the evaluations.

Evaluating (400) memory affinity among nodes according to the method of FIG. 7 includes evaluating (800) memory affinity according to memory availability among the nodes.

In the method of FIG. 7, evaluating (800) memory affinity according to memory availability among the nodes includes determining (804) the number of unallocated frames for each memory node. A number of unallocated frames for each memory node may be ascertained from frame table (424). In the method FIG. 7, frame table (424) is represented as a data structure that associates frame numbers (428) for frames in memory nodes with allocation flags (426) that indicate whether a frame of memory is allocated. Determining (804) a number of unallocated frames for each memory node according to the method of FIG. 7 may be carried out by counting the number of unallocated frames located in each memory node and storing the total number of unallocated frames for each memory node in unallocated frame totals table (806). In some embodiments, an operating system may maintain a frame table (424) for each memory node in the form of a free frame list. In those embodiments, determining (804) a number of unallocated frames for each memory node may be carried out by counting the number of entries in the free frame list of each memory node and storing the total number of unallocated frames for each memory node in an unallocated frame totals table such as the one illustrated at reference (806).

Unallocated frame totals table (806) of FIG. 7 stores the number of unallocated frames in the memory installed on each node of the system. Each record of the unallocated frame totals table (806) associates a memory node (404) with an unallocated frame total (808).

Evaluating (800) memory affinity according to memory availability among the nodes according to the method of FIG. 7 also includes calculating (810) weighted coefficients of memory affinity (502) between a processor node and memory nodes according to the following formula 1:

$$Formula 1 \text{:} {A}_{i} = \frac{{F}_{i}}{{\sum }_{n = 0}^{N - 1} {F}_{n}}$$

where Aᵢ is the weighted coefficient of memory affinity (502) for the processor node for the i^{th} memory node, Fᵢ is the number of unallocated frames on the i^{th} memory node, N is the number of memory nodes on the system, and the denominator of Formula 1 is the total of all unallocated frames on all memory nodes. For processor node 0 and memory node 0 in memory affinity table (402), for example, a weighted coefficient of memory affinity Aᵢ may be calculated according to Formula 1 where the number of unallocated frames on the i^{th} memory node Fᵢ is taken from table (806) as 100, the number of memory nodes N is 3, the total of all unallocated frames on all memory nodes is summed from column (808) of table (806) as 200, and Aᵢ is calculated as 0.50=100÷200.

In the method of FIG. 7, the evaluations of memory affinity (502) are weighted coefficients of memory affinity (502), but these weighted coefficients of memory affinity (502) are used for exemplary purposes only. In fact, evaluations of memory affinity (502) of FIG. 7 may also be represented as memory affinity ranks that indicate the order in which an operating system will allocate memory to a processor node from memory nodes and in other ways as will occur to those of skill in the art.

In the method of FIG. 7, calculating (810) a weighted coefficient of memory affinity (502) may include storing a weighted coefficient of memory affinity (502) for each memory node in a memory affinity table (402). Each record of memory affinity table (402) associates an evaluation (502) of memory affinity for a memory node (404) to a processor node (403).

The method of FIG. 7 also includes allocating (410) memory in dependence upon the evaluations of memory affinity. Allocating (410) memory in dependence upon the evaluations may be carried out by determining whether there are any memory nodes in the system having evaluated affinities with a processor node, identifying the memory node with the highest memory affinity rank, and determining whether the node with highest memory affinity rank has unallocated frames, and so on, as described in detail above in this specification.

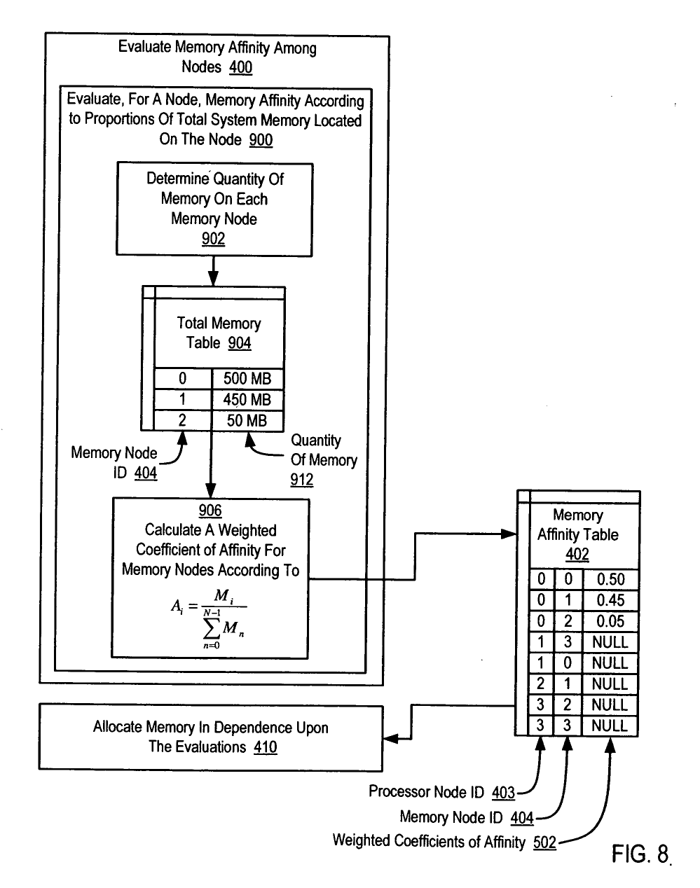

For further explanation, FIG. 8 sets forth a flow chart illustrating a further exemplary method for memory allocation in a multi-node computer according to embodiments of the present invention that includes evaluating (400) memory affinity among nodes and allocating (410) memory in dependence upon the evaluations. Evaluating (400) memory affinity among nodes according to the method of FIG. 8 includes evaluating (900), for a node, memory affinity according to the proportion of total system memory located on the node. Total system memory represents the total quantity of random access memory installed on memory nodes of the system.

In the method of FIG. 8, evaluating (900), for a node, memory affinity according to the proportion of total system memory located on the node includes determining (902) the quantity of installed memory on each memory node. Determining (902) the quantity of memory on each memory node according to the method of FIG. 8 may be carried out by reading a system parameter for each memory node entered by a system administrator when the memory node was installed that contains the quantity (912) of memory on the memory node. In other embodiments, determining (902) the quantity of memory on each memory node may be carried out by counting the memory during the initial startup of the system, that is, while the system is ‘booting.’

In the method of FIG. 8, determining (902) the quantity of memory on each memory node may include storing the quantity (912) of memory for each memory node in a total memory table (904). Each record of total memory table (904) of FIG. 8 associates a memory node (404) with a quantity of memory (912) for each memory node identified in table (904).

Evaluating (900), for a node, memory affinity according to the proportion of total system memory located on the node according to the method of FIG. 8 also includes calculating (906) weighted coefficients of memory affinity (502) between a processor node and memory nodes installed on the system according to the following formula 2:

$$Formula 2 \text{:} {A}_{i} = \frac{{M}_{i}}{{\sum }_{n = 0}^{N - 1} {M}_{n}}$$

where Aᵢ is the weighted coefficient of memory affinity (502) for the processor node for the i^{th} memory node, Mᵢ is the quantity of memory on the i^{th} memory node, N is the number of memory nodes on the system, and the denominator of Formula 2 is the total quantity of memory on all memory nodes. For processor node 0 and memory node 0 in memory affinity table (402), for example, a weighted coefficient of memory affinity Aᵢ may be calculated according to Formula 2 where the quantity of memory on the i^{th} memory node Mᵢ is taken from table (904) as 500 MB, the number of memory nodes N is 3, the total quantity of memory on all memory nodes, summed from column (912) of table (904), is 1000 MB, and Aᵢ is calculated as 0.50=500÷1000.

In the method of FIG. 8, calculating (906) a weighted coefficient of memory affinity (502) may be carried out, for example, during system powerup or during early boot phases and may include storing a weighted coefficient of memory affinity (502) for each memory node in a memory affinity table such as the one illustrated for example at reference (402) of FIG. 8. Each record of memory affinity table (402) associates an evaluation (502) of memory affinity for a memory node (404) to a processor node (403).

The method of FIG. 8 also includes allocating (410) memory in dependence upon the evaluations of memory affinity. Allocating (410) memory in dependence upon the evaluations may be carried out by determining whether there are any memory nodes in the system having evaluated affinities with a processor node, identifying the memory node with the highest memory affinity rank, and determining whether the node with highest memory affinity rank has unallocated frames, and so on, as described in detail above in this specification.

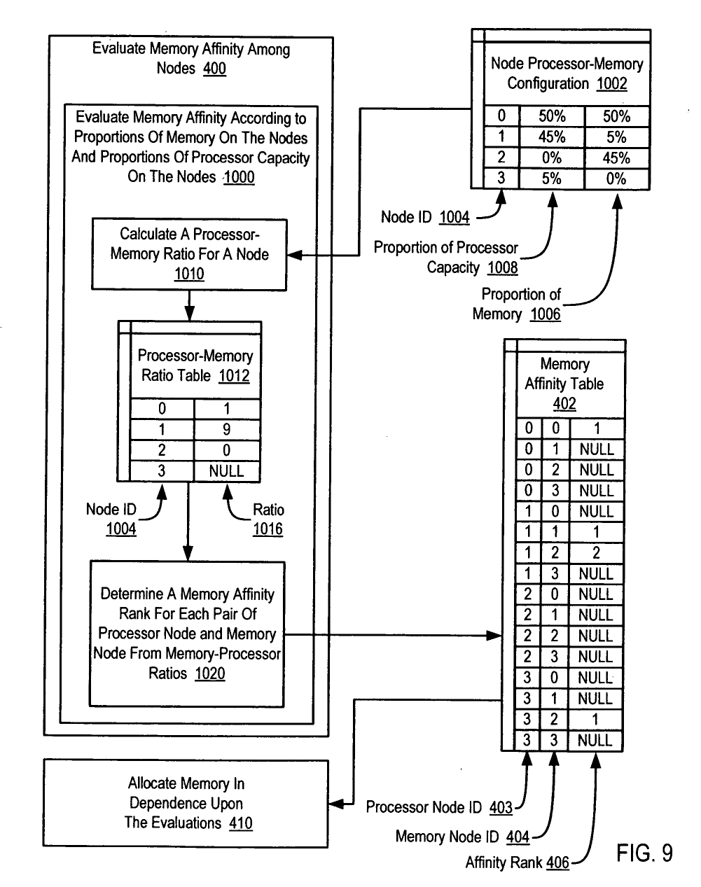

For further explanation, FIG. 9 sets forth a flow chart illustrating a further exemplary method for memory allocation in a multi-node computer according to embodiments of the present invention that includes evaluating (400) memory affinity among nodes and allocating (410) memory in dependence upon the evaluations. Evaluating (400) memory affinity among nodes according to the method of FIG. 9 includes evaluating (1000) memory affinity according to proportions of memory (1006) on the nodes and proportions of processor capacity (1008) on the nodes. A proportion of memory (1006) for each node may be represented by the ratio of the quantity of memory installed on a memory node to the total quantity of system memory. A proportion of processor capacity (1008) on each node may be represented by the ratio of the processor capacity on a processor node to the total quantity of processor capacity for all processor nodes in the system. In FIG. 9, a proportion of memory (1006) for each node and a proportion of processor capacity (1008) for each node may be obtained from system parameters entered by a system administrator when the system was installed.

The node processor-memory configuration (1002) in the example of FIG. 9 is a data structure, in this example a table, that associates a proportion of memory (1006) and proportion of processor capacity (1008) with a node identifier (1004). In this example, node 0 contains 50% of the total system memory and 50% of the processor capacity of the system, node 1 contains 5% of the total system memory and 45% of the processor capacity of the system, node 2 contains 45% of the total system memory and has no processors installed on the node, and node 3 has no memory installed upon it and contains 5% of the processor capacity of the system.

In the method of FIG. 9, evaluating (1000) memory affinity according to proportions of memory (1006) on the nodes and proportions of processor capacity (1008) on the nodes includes calculating (1010) a processor-memory ratio for a node. Calculating (1010) a processor-memory ratio for a node according to the method of FIG. 9 may be carried out by dividing the proportion of process capacity (1008) on the node by the proportions of memory (1006) installed on the node, and storing the result (1016) in processor-memory ratio table (1012).

Processor-memory ratio table (1012) of FIG. 9 associates a node identifier (1004) with a processor-memory ratio (1016). In FIG. 9, a processor-memory ratio (1016) of ‘1’ indicates that a node contains an equal proportion of processor capacity and proportion of memory relative to the entire system. A processor-memory ratio (1016) greater than ‘1’ indicates that a node contains a larger proportion of processor capacity than proportion of memory relative to the entire system, while a processor-memory ratio (1016) less than ‘1’ indicates that a node contains a smaller proportion of processor capacity than proportion of memory relative to the entire system. In FIG. 9, a processor-memory ratio (1016) of ‘0’ indicates that no processors are installed on the node, while a processor-memory ratio (1016) of ‘NULL’ indicates that no memory is installed on the node. For node 3, for example, which has no memory installed upon it, dividing the proportion of process capacity (1008) on the node by the proportions of memory (1006) installed on the node divides by zero, indicated by a NULL entry for node 3 in table (1012). The NULL entry is appropriate; there is no useful memory affinity for purposes of memory allocation between a processor node and another node with no memory on it.

Evaluating (1000) memory affinity according to proportions of memory (1006) on the nodes and proportions of processor capacity (1008) on the nodes according to the method of FIG. 9 also includes determining (1020) a memory affinity rank for each processor node for each memory node using memory-processor ratios. Determining (1020) a memory affinity rank for each processor node for each memory node using memory-processor ratios may include storing a memory affinity rank for a processor node for a memory node in memory affinity table (402). Each record associates an evaluation (406) of memory affinity for a memory node (404) to a processor node (403). The evaluations of memory affinity in the memory affinity table (402) are ordinal integer memory affinity ranks (406) that indicate the order in which an operating system will allocate memory to a processor node (403) from a memory node (404) identified in the table.

Memory affinity is between a memory node and a processor node, not between a memory node and another memory node. That a node has a processor-memory ratio (1016) of 0 means that the node contains no processors, only memory and there is therefore no useful memory affinity for purposes of memory allocation between that node and any other node containing memory. For good order and completeness, table (402) still carries an entry for each such processor in its ‘processor node’ column (403), although such nodes are not substantively ‘processor nodes.’ In the method of FIG. 9, therefore, for node 2, a processor node with a processor-memory ratio (1016) of ‘0,’ determining (1020) a memory affinity rank between that node and other memory nodes may be carried out by storing ‘NULL’ as a memory affinity rank (406) for such a node. In FIG. 9, for example, NULL is stored in all memory affinity ranks (406) for processor node 2, a ‘processor node’ containing no processors.

That a node has a processor-memory ratio equal to or less than 1 indicates that the node's resources are generally, reasonably balanced. A node with half the processing capacity of a system and half the memory may reasonably be expected to be able to satisfy all of its memory requirements using memory from the same node. In the method of FIG. 9, therefore, for node 0, a processor node with a processor-memory ratio (1016) that is less than or equal to ‘1,’ determining (1020) a memory affinity using memory-processor ratios may also be carried out by storing ‘1’ in a memory affinity rank (406) for such a processor node for a memory node (404) representing the same node and storing ‘NULL’ in the other memory affinity ranks (406) associated with the processor node. In this case, a memory affinity rank of ‘1’ indicates highest memory affinity, ‘2’ less memory affinity, ‘3’ still less memory affinity, and so on. In FIG. 9, for example, node 0 has a processor-memory ratio of ‘1,’ and a memory affinity rank of ‘1’ is specified for processor node 0 with memory node 0 (both the same node), while ‘NULL’ is stored as the memory affinity rank (406) for all other memory nodes for processor node 0.

That a processor node has a processor-memory ratio of more than one means that the node has relatively more processing capacity than memory; such a node is likely to need memory allocated from other nodes. Initial allocations of memory for such a node may come from the node itself as long as it has memory available, and when memory must come from another node, allocating memory from other nodes may prefer memory from nodes with processor-memory ratios less than one, that is, nodes relatively heavy with memory. In the method of FIG. 9, therefore, for node 1, a processor node with a processor-memory ratio (1016) that is greater than ‘1,’ determining (1020) a memory affinity rank using memory-processor ratios may be carried out by storing a value of ‘1’ as a memory affinity rank (406) for such a processor node for a memory node (404) representing the same node and storing increasing ordinal integers as memory affinity ranks (406) for other memory nodes that have a processor-memory ratio (1016) less than ‘1’ and storing ‘NULL’ as memory affinity ranks (406) for other memory nodes having evaluated affinities for the processor node.

In this example, low memory affinity rank values represent high memory affinity. A memory affinity rank value of 1 represents highest memory affinity, memory affinity rank of 2 is a lower memory affinity, 3 is lower, and so on. Non-null memory affinity rank values greater than one are ordered with the memory node having the lowest processor-memory ratio (1016) ranked ‘2,’ and the memory node having the second lowest processor-memory ratio (1016) ranked ‘3,’ and so on. In table (402) of FIG. 9, for example, ‘1’ is stored as the memory affinity rank for processor node 1 for memory node 1. ‘2’ is stored as the memory affinity rank for processor node 1 for memory node 2. NULL is stored as all other memory affinity ranks for processor node 1.

That a processor node has a processor-memory ratio of NULL means that the node has no memory installed on it; such a node needs memory allocated from other nodes. Evaluating memory affinity for a node with no memory may be implemented in dependence upon processor-memory ratios of memory nodes in the system. That is, for example, evaluating memory affinity for a node with no memory may be implemented by assigning a relatively high memory affinity to memory nodes having processor-memory ratios less than one, that is, to nodes relatively heavy with memory.

In the method of FIG. 9, therefore, for node 3, a processor node having a processor-memory ratio (1016) that is NULL, determining (1020) a memory affinity rank using memory-processor ratios may be carried out by storing increasing ordinal integers as memory affinity ranks (406) for memory nodes with a processor-memory ratio (1016) less than ‘1’ and storing ‘NULL’ as memory affinity ranks (406) for other memory nodes having evaluated affinities for the processor node. In this example, low memory affinity rank values represent high memory affinity. A memory affinity rank value of 1 represents highest memory affinity, memory affinity rank of 2 is a lower memory affinity, memory affinity rank of 3 is a still lower memory affinity, and so on. Non-null memory affinity rank values are ordered with the memory node having the lowest processor-memory ratio (1016) ranked ‘1,’ and the memory node having the second lowest processor-memory ratio (1016) ranked ‘2,’ and so on. In table (402) of FIG. 9, for example, ‘1’ is stored in the memory affinity rank for processor node 3 and memory node 2. NULL is stored in all other memory affinity ranks for processor node 3.

The method of FIG. 9 also includes allocating (410) memory in dependence upon the evaluations of memory affinity. Allocating (410) memory in dependence upon the evaluations may be carried out by determining whether there are any memory nodes in the system having evaluated affinities with a processor node, identifying the memory node with the highest memory affinity rank, and determining whether the node with highest memory affinity rank has unallocated frames, and so on, as described in detail above in this specification.

Exemplary embodiments of the present invention are described largely in the context of a fully functional computer system for memory allocation in a multi-node computer. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for memory allocation in a multi-node computer, the method comprising:
evaluating memory affinity among nodes; and
allocating memory in dependence upon the evaluations.

2. The method of claim 1 wherein:
evaluating memory affinity further comprises assigning to nodes weighted coefficients of memory affinity, each weighted coefficient representing a desirability of allocating memory of a node to a processor of a node; and
allocating memory further comprises allocating memory in dependence upon the weighted coefficients of memory affinity.

3. The method of claim 1 wherein allocating memory in dependence upon the evaluations further comprises allocating memory from a node as a proportion of a total quantity of memory to be allocated.

4. The method of claim 1 wherein allocating memory in dependence upon the evaluations further comprises allocating memory from a node as a proportion of a total number of memory allocations.

5. The method of claim 1 wherein evaluating memory affinity further comprises evaluating memory affinity according to memory availability among the nodes.

6. The method of claim 1 wherein evaluating memory affinity further comprises evaluating, for a node, memory affinity according to the proportion of total system memory located on the node.

7. The method of claim 1 wherein evaluating memory affinity further comprises evaluating memory affinity according to proportions of memory on the nodes and proportions of processor capacity on the nodes.

8. An apparatus for memory allocation in a multi-node computer, the system comprising a computer processor and a computer memory operatively coupled to the computer processor, the computer memory having disposed within it computer program instructions capable of:
evaluating memory affinity among nodes; and
allocating memory in dependence upon the evaluations.

9. The apparatus of claim 8 wherein:
evaluating memory affinity further comprises assigning to nodes weighted coefficients of memory affinity, each weighted coefficient representing a desirability of allocating memory of a node to a processor of a node; and
allocating memory further comprises allocating memory in dependence upon the weighted coefficients of memory affinity.

10. The apparatus of claim 8 wherein allocating memory in dependence upon the evaluations further comprises allocating memory from a node as a proportion of a total quantity of memory to be allocated.

11. The apparatus of claim 8 wherein allocating memory in dependence upon the evaluations further comprises allocating memory from a node as a proportion of a total number of memory allocations.

12. A computer program product for memory allocation in a multi-node computer, the computer program product disposed upon a signal bearing medium, the computer program product comprising computer program instructions capable of:
evaluating memory affinity among nodes; and
allocating memory in dependence upon the evaluations.

13. The computer program product of claim 12 wherein the signal bearing medium comprises a recordable medium.

14. The computer program product of claim 12 wherein the signal bearing medium comprises a transmission medium.

15. The computer program product of claim 12 wherein:
evaluating memory affinity further comprises assigning to nodes weighted coefficients of memory affinity, each weighted coefficient representing a desirability of allocating memory of a node to a processor of a node; and
allocating memory further comprises allocating memory in dependence upon the weighted coefficients of memory affinity.

16. The computer program product of claim 12 wherein allocating memory in dependence upon the evaluations further comprises allocating memory from a node as a proportion of a total quantity of memory to be allocated.

17. The computer program product of claim 12 wherein allocating memory in dependence upon the evaluations further comprises allocating memory from a node as a proportion of a total number of memory allocations.

18. The computer program product of claim 12 wherein evaluating memory affinity further comprises evaluating memory affinity according to memory availability among the nodes.

19. The computer program product of claim 12 wherein evaluating memory affinity further comprises evaluating, for a node, memory affinity according to the proportion of total system memory located on the node.

20. The computer program product of claim 12 wherein evaluating memory affinity further comprises evaluating memory affinity according to proportions of memory on the nodes and proportions of processor capacity on the nodes.
